(19) United States
(12) Patent Application Publication
(10) Pub. No.: US 2006/0263144 A1
(43) Pub. Date: Nov. 23, 2006

(54) Marking instrument

(76) Inventor: Liang Wang, San Gabriel, CA (US)

Correspondence Address: LIANG WANG, 8259 E. LIVE OAK ST., SAN GABRIEL, CA, 91776, US

(21) Appl. No.: 11/140,119

(22) Filed: May 23, 2005

(51) Int. Cl. B43K 5/00; B43M 11/06; B43K 7/00

(52) U.S. Cl. 401/209; 401/199; 401/198

(57) ABSTRACT

A marking instrument comprising: a marking tip for applying marking fluid on surface of written media, a first reservoir chamber having a fluid supply outlet for supplying the marking tip with marking fluid, in characterized that said instrument further comprises at least one additional reservoir chamber located inside or outside of the first reservoir chamber, the additional reservoir chamber is provided with a fluid supply outlet for supplying marking fluid to the first reservoir chamber, the first reservoir chamber comprises a fluid core having absorptive capacity, and the fluid core comprises an inlet and an outlet, wherein the inlet of the fluid core communicates with the fluid supply outlet of the additional reservoir chamber and the outlet of the fluid core communicates with the marking tip, and wherein a first exhaust outlet is formed on the first reservoir chamber and communicates with the fluid core such that the marking fluid in the additional reservoir chamber is conducted to the marking tip via the fluid core of the first reservoir chamber so as to supply marking fluid continually to the marking tip. The marking instrument of the present invention not only increases the volume for marking fluid but also effectively prevents and avoids leakage. It also extends writing time and has fluent writing and even handwriting in dark or light. The marking instrument of the present invention has a simple and reasonable structure, low cost and long working life and is convenient for wholesale manufacture.

### FIELD OF THE INVENTION

The present invention relates to a marking instrument. In particular, the invention relates to a color pen, felt tip pen, fiber tip pen, ball pen, pen and any other marking instrument.

### SUMMARY OF THE PRIOR ART

At present, there are a variety of different marking instruments suffering the following disadvantages: 1. the volume for storing marking fluid is too small and the frequency for refilling marking fluid or changing refills is very high; 2. it is easy to occur ink leakage under variation of temperature and/or atmosphere if marking instruments carry the marking fluid more than they can bear, and thus the current marking instruments have low leak resistance and small volume for marking fluid; and 3, for the expendable marking instruments, it is very quick to be used up and thrown away even if they look new. Such marking instruments have low use rate.

There are some improvements made to overcome the above problems. For example, WO93/05966 discloses a marking instrument, and CN1086173A relates to a marking instrument. Both of them disclose solutions of large and small reservoir chambers for resolving the problem of low volume for marking fluid. In those solutions, the reservoir chambers are divided into large and small reservoir chambers by a diaphragm member, and a marking tip is retractable so as to open the diaphragm member to supply marking fluid from the larger reservoir chamber to the smaller reservoir chamber. The advantage thereof is to increase the volume of the marking instrument for marking fluid, but it has been found that the marking fluid can continue to flow or ooze to the marking tip while writing when or after the marking fluid is supplied continually from the larger reservoir chamber to the smaller reservoir chamber. One of the reasons is that the marking fluid is supplied from the closed larger reservoir chamber to the smaller reservoir chamber by way of opening a valve with longitudinal movement of a moveable member, resulting in generating pressure and/or attraction force in the reservoir chambers. In addition, the marking fluid in the big reservoir chamber is far more than the marking fluid in the small reservoir chamber. It is apparent that more pressure from the big reservoir chamber is applied to the small reservoir chamber during transfer process. The marking fluid in the reservoir chambers suffers multiple pressure and /or attraction force and has to exit continually from the direction of the marking tip communicating therewith to cause the marking instrument to occur leakage. Furthermore, since it is very easy to decrease the marking fluid in the small reservoir chamber, the marking fluid in the big reservoir chamber has to be supplied continually to the small reservoir chamber via opened valve, i.e. it is very easy that the marking fluid in the small reservoir chamber varies in different time. It is apparent that handwriting is thick or thin, dark or light and it is uneven, and the marking tip does not write fluently.

Some improvements have been achieved based on the above structure. For example, WO96/14998 discloses a marking instrument similar to WO93/05966 and CN1086173A. It provides a small reservoir chamber being annular resiliently deformable member to draw fluid through the supply channel from the tip during forward displacement of the tip by increasing the volume of the chamber. However, it is impossible to draw back the marking fluid from the tip if more marking fluid flows and ooze from the tip or if it draws air rather than the marking fluid from the tip. For the marking instruments using general tips having a ball, it is impossible to draw back the fluid leaked or pressed out of the instruments because they are a closed type. Therefore, leakage still occurs. In addition, there is no improvement for the disadvantage of writing and handwriting and still exits unsmooth and uneven writing and handwriting.

### SUMMARY OF THE INVENTION

The object of the present invention is to provide a marking instrument with increasing volume for marking fluid and effectively preventing and avoiding leakage so as to overcome the problems existing in the prior art.

Another object of the present invention is to extend writing time and have fluent writing and uniform handwriting in dark or light.

The further object of the present invention is that a fluid core and each of additional reservoir chambers has the similar or same amount of marking fluid which is hard to cause leakage even if there is shock in the fluid core or the additional reservoir chambers to generate pressure or attraction force, and avoids leakage arising from transferring marking fluid in different storing chambers.

The further object of the present invention is to provide a marking instrument having a simple and reasonable structure, and being of low cost and convenient for wholesale manufacture.

The present invention provides a marking instrument, the marking instrument comprising: a marking tip for applying marking fluid on surface of written media, a first reservoir chamber having a fluid supply outlet for supplying the marking tip with marking fluid, in characterized that said instrument further comprises at least one additional reservoir chamber located inside or outside of the first reservoir chamber, the additional reservoir chamber is provided with a fluid supply outlet for supplying marking fluid to the first reservoir chamber, the first reservoir chamber comprises a fluid core having absorptive capacity, and the fluid core comprises an inlet and an outlet, wherein the inlet of the fluid core communicates with the fluid supply outlet of the additional reservoir chamber and the outlet of the fluid core communicates with the marking tip, and wherein a first exhaust outlet is formed on the first reservoir chamber and communicates with the fluid core such that the marking fluid in the at least one additional reservoir chamber is conducted to the marking tip via the fluid core of the first reservoir chamber so as to supply marking fluid continually to the marking tip.

The marking instrument of the present invention further comprises a second exhaust outlet disposed between the additional reservoir chamber and the fluid core or on the fluid core, and the second exhaust outlet communicates with the first exhaust outlet.

According to the present invention, the at least one additional reservoir chamber disposed outside of the first reservoir chamber and the first reservoir chamber are arranged end to end along the length direction of the marking instrument, and the at least one additional reservoir chamber is located above the first reservoir chamber.

According to the present invention, the at least one additional reservoir chamber disposed outside of the first reservoir chamber and the first reservoir chamber are arranged transversely along the length direction of the marking instrument.

According to the present invention, the at least one additional reservoir chamber disposed inside of the first reservoir chamber is located inside or outside of the fluid core.

According to the present invention, the fluid core is a fiber fluid core.

According to the present invention, the additional reservoir chamber further comprises a hose and bottom, the fluid supply outlet is formed at the bottom, and the fluid supply outlet is an opening having closed slot which can be opened or the fluid supply outlet is provided with a stemming.

According to the present invention, the additional reservoir chamber further comprises a fluid supply device.

According to the present invention, the fluid supply device comprises a sealer disposed on the fluid supply outlet and a switch device connecting with the sealer.

According to the present invention, the marking instrument further comprises an air inlet formed at the top of the additional reservoir chamber, and the fluid supply device comprises a sealer disposed on the fluid supply outlet, a second sealer on the air inlet and a switch device connecting the sealer and the second sealer.

According to the present invention, the marking instrument further comprises an fluid inlet formed at the top of the first reservoir chamber, the additional reservoir chamber is disposed above the top, and the fluid supply outlet of the additional reservoir chamber and the top of the first reservoir chamber seal with each other and relatively rotatably connect with each other.

The marking instrument further comprises a seal washer disposed between the top of first reservoir chamber and the additional reservoir chamber.

The marking instrument of the present invention further comprises marks on the first reservoir chamber and the additional reservoir chamber for aligning.

The marking instrument of the present invention further comprises a stopper or stopping channel at the coupling place of the additional reservoir chamber and the first reservoir chamber and a stopping channel or stopper at the coupling place of the first reservoir chamber and the additional reservoir chamber for fitting with the stopper or stopping channel.

According to the present invention, the additional reservoir chamber comprises a fluid core.

The present invention comprises at least one additional reservoir chamber arranged inside or outside of a first reservoir chamber, and uses a fluid core having gaps and absorptive capacity put in the first reservoir chamber such that marking fluid discharged from the additional reservoir chamber is absorbed by the fluid core and then the fluid core supplies the marking fluid continually to a marking tip to realize the purpose of adding marking fluid. Adding time may be less. It may also add once. It is very convenient for operation. When supplying marking fluid in the additional reservoir chamber to the fluid core in the first reservoir chamber, the air in the fluid core discharged quickly from a first exhaust outlet communicating with the fluid core to outside to leave room for the marking fluid discharged from the additional reservoir chamber so as to eliminate pressure against to the marking fluid in the fluid core and effectively prevent and avoid leakage occurring at the marking tip during the marking instrument transferring storage position. In addition, it can avoid leakage as long as the fluid core having strong absorptive capacity to absorb marking fluid and with assistance of the first exhaust outlet of the first reservoir chamber even if there is shock in the additional reservoir chamber or the fluid core generating pressure and attraction force.

When temperature and atmosphere vary, the air expanding in the additional reservoir chamber or the fluid core can be discharged from the first exhaust outlet of the first reservoir chamber to outside and will not generate pressure against the additional reservoir chamber or the fluid core so as to eliminate leakage caused by variation of temperature and atmosphere.

The amount of the marking fluid stored in the additional reservoir chamber is at least similar to or the same as the amount of the marking fluid stored in the first reservoir chamber such that each structure storing fluid has a big volume. The time of supplying marking fluid to the fluid core may also be less. For the marking instrument only having one additional reservoir chamber, it may add marking fluid once. In this way, the marking fluid in the fluid core may be very stably locked in gaps of the fluid core and the amount of the marking fluid does not exceed the original amount of the fluid core. Therefore, it still keeps not to leak, and has fluent and uniform writing and long working life. The marking instrument of the present invention has advantages of simple and reasonable structure, low cost and long working life and is convenient for wholesale manufacture.

### BRIEF DESCRIPTION OF THE DRAWINGS

FIG. 1 is a schematic cross-section of the marking instrument according to the first embodiment of the present invention;

FIG. 2 is a schematic cross-section of the marking instrument according to the second embodiment of the present invention;

FIG. 3 is a schematic cross-section of the marking instrument according to the third embodiment of the present invention;

FIG. 4 is a schematic cross-section of the marking instrument according to the fourth embodiment of the present invention;

FIG. 5 is a schematic cross-section of the marking instrument according to the fifth embodiment of the present invention;

FIG. 6 is a schematic cross-section of the marking instrument according to the sixth embodiment of the present invention;

FIG. 7 is a schematic cross-section of the marking instrument according to the seventh embodiment of the present invention;

FIG. 8 is a schematic cross-section of the marking instrument according to the eighth embodiment of the present invention;

FIG. 9 is a schematic cross-section of the marking instrument according to the ninth embodiment of the present invention;

FIG. 10 is a schematic cross-section of the marking instrument according to the tenth embodiment of the present invention;

FIG. 11 is a schematic cross-section of the marking instrument according to the eleventh embodiment of the present invention;

FIG. 12 is a schematic cross-section of the fluid supply device of FIG. 11 in working status;

FIG. 13 is a schematic cross-section of the marking instrument according to the twelfth embodiment of the present invention;

FIG. 14 is a schematic cross-section of the marking instrument according to the thirteenth embodiment of the present invention;

FIG. 15 is a schematic cross-section of the marking instrument according to the fourteenth eleventh embodiment of the present invention;

FIG. 16 is a schematic cross-section of the marking instrument according to the fifteenth embodiment of the present invention;

FIG. 17 is a schematic view showing the flow of the air in the second exhaust outlet when the additional reservoir chamber of FIG. 16 rotating 180°;

FIG. 18 is an exploded view showing the first reservoir chamber and additional reservoir chamber of FIG. 16 in coupling status, wherein the above is a partial schematic diagram of the additional reservoir chamber, and the below is a partial schematic view of the first reservoir chamber;

FIG. 19 is a partial cross-section showing the connection of the first reservoir chamber and additional reservoir chamber of FIG. 18;

FIG. 20 is a schematic cross-section of the marking instrument according to the sixteenth embodiment of the present invention;

FIG. 21 is a schematic cross-section of the marking instrument according to the seventeenth embodiment of the present invention;

FIG. 22 is a schematic cross-section of the marking instrument according to the eighteenth embodiment of the present invention; and

FIG. 23 is a cross-section taken along F-F of FIG. 22.

1—marking tip, 11—ball, 12—ball sleeve, 13—conducting fluid core, 14—conducting fluid core sleeve, 15—second conducting fluid core, 2—fluid core having absorptive capacity, 20—inlet, 21—outlet, 22—second exhaust outlet, 23—housing, 3—first reservoir chamber, 30, 30′—first exhaust outlet, 31—fixing sleeve, 32—the top of the first reservoir chamber, 331—partition, 320—fluid inlet, 321, 321′—seal washer, 322, 322′—second opening, 33—recess, 34, 34′—mark, 35—stopping channel, 36—fluid supply outlet of the first reservoir chamber, 4, 4′—additional reservoir chamber, 40—flange, 401—stopper, 41, 41′—hose, 42, 42′—bottom, 421—top, 422—chamber casing, 423—center shaft, 43, 43′—fluid supply outlet, 430—second fluid supply outlet, 431—opening having closed slot, 432—second fluid outlet, 44—stemming, 46—cover, 47—seal ring, 48—opening, 49—air inlet, 5—fluid supply device, 51—sealer, 52—switch device, 53, 53′—second sealer, 6—restoring spring, 61—spring holder, 7—pen tube, 71—third exhaust outlet, 8—cap.

### DEATILED DESCRPTION OF THE INVENTION

Referring to FIGS. 1-23, the present invention provides a marking instrument comprising: a marking tip 1 for applying marking fluid against the surface of written media, a first reservoir chamber 3 having a fluid supply outlet 36 for supplying the marking tip 1 with marking fluid, and at least one additional reservoir chamber 4 disposed inside or outside of the first reservoir chamber 3. The additional reservoir chamber 4 is provided with a fluid supply outlet 43 for supplying the first reservoir chamber 3 with marking fluid. The first reservoir chamber 3 further comprises a fluid core 2 having adsorptive capacity, and the fluid core 2 comprises an inlet 20 and outlet 21, wherein the inlet 20 of the fluid core 2 communicates with the fluid supply outlet 43 of the additional reservoir chamber 4. A part of the marking tip 1 passes through the fluid supply outlet 36 and the outlet 21 of the fluid core 2 to communicate with the fluid core 2. First exhaust outlet 30 is disposed at the first reservoir chamber 3, and the first exhaust outlet 30 communicates with the fluid core 2. The fluid core 2 in the first reservoir chamber 3 may firstly absorb marking fluid for writing directly. When the marking fluid in the fluid core 2 is used up or remains a little, the marking fluid in at least one additional reservoir chamber 4 is put into service in turn such that the marking fluid is discharged from the fluid supply outlet 43 of the additional reservoir chamber 4 and flows quickly into the fluid core 2 through inlet 20 to allow the marking fluid in at least one additional reservoir chamber 4 to pass in turn and stably through the fluid core 2 of the first reservoir chamber 3 to communicate with the marking tip 1 so as to continually supply the marking tip 1 with marking fluid. In this way, the marking instrument of the present invention can write fluidly and uniformly in dark or light. Since the first exhaust outlet 30 communicates with the fluid core 2, the air in the additional reservoir chamber 4 or fluid core 2 can be discharged quickly from the first exhaust outlet 30 to the outside to leave room for the marking fluid after the marking fluid of the additional reservoir chamber 4 flows into the fluid core 2 of the first reservoir chamber 3 so as to effectively prevent and avoid dropping and leaking.

At least one additional reservoir chamber is arranged outside of the first reservoir chamber. The first reservoir chamber and the additional reservoir chamber are arranged end to end along the length direction of the marking instrument. Please refer to the following example for the details.

Referring to FIG. 1, an additional reservoir chamber 4 is disposed above the first reservoir chamber 3 and is provided with a fluid supply outlet 43 for supplying marking fluid to the first reservoir chamber 3. The fluid supply outlet 43 may be a small aperture. It is not easy for the marking fluid stored in the additional reservoir chamber 4 to flow out due to the smaller diameter of the aperture. The first reservoir chamber 3 is also provided with fluid core 2 having gaps and adsorptive capacity. The fluid core 2 comprises an inlet 20 and outlet 21, and the inlet 20 corresponds to and communicates with the fluid supply outlet 43 of the additional reservoir chamber 4. A part of marking tip 1 is inserted into the outlet 21 of the fluid core 2. The first reservoir chamber 3 is also provided with a first exhaust outlet 30 communicating with the fluid core 2. In this embodiment, the additional reservoir chamber 4 may be formed into a pressable hose 41, and it may also be formed into a pressable structure having multiple tubes muff-coupling each other. The fluid supply outlet 43 may be disposed at the bottom of the additional reservoir chamber 4. In this embodiment, firstly, the fluid core 2 of the first reservoir chamber 3 may be charged with marking fluid in amount it can bear, in this way, to prevent the fluid core 2 and the marking tip 1 from leaking. In addition, in this embodiment, the additional reservoir chamber 4 is also charged with marking fluid in amount similar to or the same as the amount of fluid core 2. When the marking fluid in the fluid core 2 remains a little, pressing the additional reservoir chamber 4 (hose 41) to discharge the marking fluid of the additional reservoir chamber 4 completely from the fluid supply outlet 43 into the fluid core 2 such that the fluid core 2 absorbs the marking fluid of the additional reservoir chamber 4. The embodiment is simple and easy for use, and it is able to continually supply marking fluid to the marking tip 1 to allow the marking instrument to be reused twice. Furthermore, since the amount absorbed newly by the fluid core 2 is the same as or similar to the former amount, it is able to remain not dropping or leaking as before and the marking tip 1 also remains the stable amount of fluid exiting such that the marking instrument may write fluidly and have writing uniform in dark or light and writing time doubled.

When the marking fluid of the additional reservoir chamber 4 is supplied to the fluid core 2 of the first reservoir chamber 3, the air in the fluid core 2 is quickly discharged from the first exhaust outlet 30 communicating with the fluid core 2 to the outside to leave room for the marking fluid discharged from the additional reservoir chamber 4 so as to eliminate pressure applied to marking fluid in the fluid core 2, and the marking fluid newly absorbed into the fluid core 2 is stably attached (locked) to gaps of the fluid core 2. Furthermore, in the prior art, a small part of high volume marking fluid of the big reservoir chamber is supplied to the used-up marking fluid in the small, during conversion processing, it is hard for the small reservoir chamber to bear the pressure generated by the high volume marking fluid of the big reservoir chamber so as to occur dropping and leaking. However, in the present invention, since the newly added marking fluid is similar to or the same as the former marking fluid in the fluid core 2, there is no extra pressure applied to the fluid core 2 so as to prevent such dropping and leaking. Therefore, this embodiment eliminates completely dropping and leaking of the marking tip when the marking instrument converts its storage position.

When temperature and/or atmosphere vary, it is able to discharge the air expanding in the additional reservoir chamber 4 or the fluid core 2 from the first exhaust outlet 30 of the first reservoir chamber 3 to the outside so as to eliminate completely dropping and leaking caused by variation of temperature and atmosphere. The fluid core 2 is able to catch (lock) up marking fluid even if the fluid core 2 suffers shocking or attraction force so as to avoid leakage. However, in the prior art, the big reservoir chamber and the small reservoir chamber are a closed type. If the small reservoir chamber suffers variation of temperature or atmosphere, shock or attraction force being generated therein, there is nothing for the marking fluid in the small first reservoir chamber to depend on and the marking fluid has to overflow from the marking tip connecting therewith, resulting in dropping and leaking.

Referring to FIG. 1, a housing 23 is disposed outside of the fluid core 2 to control the gaps (density) of the fluid core 2 having gaps and facilitate assembly. The fluid core 2 may use fiber fluid core as a preferable selection. The fluid core 2 may also be formed from felt material, or the like and it may also use chemical material or natural plant fiber as raw material, etc. The fluid core 2 may also use core-shape structure having multiple grooves and absorptive capacity as a fluid core. A cover 46 is disposed around hose 41 to protect the hose 41.

Referring to FIGS. 1 and 17, second exhaust outlet 22 is formed between the additional reservoir chamber 4 and the fluid core 2 and /or above the fluid core 2. The second exhaust outlet 22 communicates with the first exhaust outlet 30 so as to strongly ensure that the additional reservoir chamber 4 or the fluid core 2 does not occur any dropping or leaking under variation of temperature and atmosphere and the fluid core 2 does not occur any dropping or leaking when suffering shocking, pressing, or attraction force.

By pressing the hose 41, the marking fluid in the additional reservoir chamber 4 is discharged from the fluid supply outlet 43 and absorbed by the fluid core 2 having gaps, while the air pressed out of the hose 41 can be discharged from the second exhaust outlet 22 and first exhaust outlet 30 without generating any pressure against the fluid core 22 having gaps so as not to cause dropping and leaking. When releasing the hose 41, the hose 41 springs back, recovers and sucks air to draw air from the first exhaust outlet 30 in the first reservoir chamber 3 and the second exhaust outlet 22 back into the additional reservoir chamber 4 so as to avoid the risk of drawing back the marking fluid in the fluid core 2 having gaps.

The additional reservoir chamber mentioned above may be of hard materials. When it needs to supply the marking fluid in the additional reservoir chamber 4 to the fluid core of the first reservoir chamber, it may open (or chisel) a vent with simple and proper tooling on the top of the additional reservoir chamber to allow air to come into from the vent of the top and then naturally discharge the marking fluid in the additional reservoir chamber from the fluid supply outlet (the small aperture mentioned above).

A top cover of the additional reservoir chamber or a part of the top cover may be configured to be a separate part and seal the additional reservoir chamber. When it needs to supply marking fluid to the fluid core, opening the top cover or the part thereof to allow the air to come into from the top cover or the part thereof and then discharge the marking fluid in the additional reservoir chamber from the fluid supply outlet (the small aperture as the above).

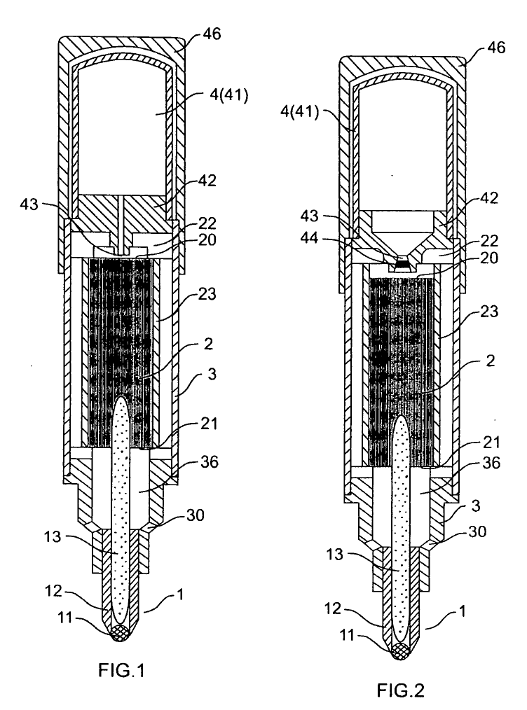

Referring to FIG. 2, the fluid supply outlet 43 of the additional reservoir chamber 4 (hose 41) may be a small aperture. Stemming 44 may also be disposed on the fluid supply outlet 43. The stemming 44 may be stemming paste or stemming member to prevent marking fluid from being evaporated during a long time storage. When it needs to add marking fluid into the fluid core 2 having gaps, pressing the hose 41 to extrude and open the stemming 44 of the fluid supply outlet 43 or drop it off so as to release marking fluid. In this case, the deformable hose 41 may serve as a fluid supply device in the additional reservoir chamber 4. Such a structure is simple and has low cost.

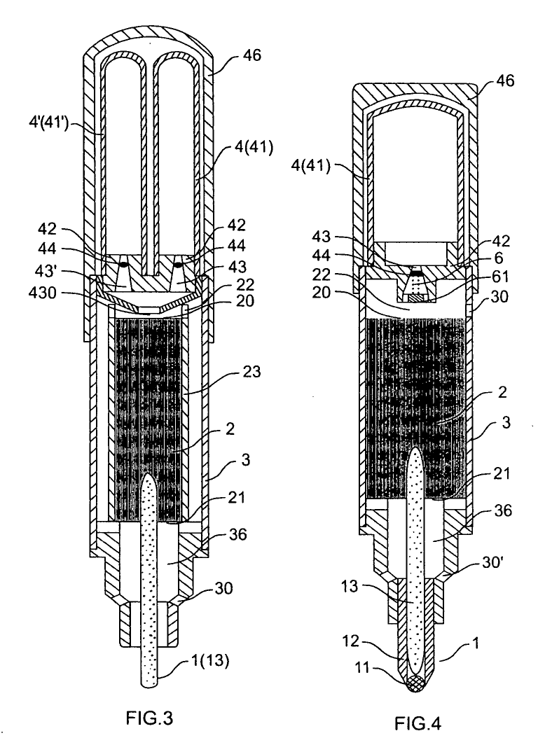

Referring to FIG. 3, two additional reservoir chambere 4 and 4′ may also be disposed above the first reservoir chamber 3 and stemming 44 may also be disposed on the fluid supply outlet 43′ of the second additional reservoir chamber 4′. When the marking fluid in the first additional reservoir chamber 4 is used up, it may select the marking fluid in the second additional reservoir chamber 4′ to add marking fluid into the fluid core 2 that lacks of marking fluid. Second fluid supply outlet 430 may be placed between the two fluid supply outlets 43, 43′ and the fluid core 2 to ensure that the marking fluid discharged from the fluid supply outlet 43 or 43′ flows smoothly into the fluid core 2 having absorptive capacity without leaking.

Referring to FIG. 4, a restoring spring 6 may be positioned on the stemming 44 of the fluid supply outlet 43, and a spring holder 61 is disposed on the fluid supply outlet 43 for holding the restoring spring 6. When it needs to add the marking fluid of the additional reservoir chamber 4 into the fluid core 2 having gaps and absorptive capacity, pressing the hose 41 to release marking fluid after the marking fluid pushes the stemming. When releasing the hose 41, the stemming 44 seals the fluid supply outlet 43 again due to the restoring force of the restoring spring 6 so as to achieve the purpose of adding marking fluid into the fluid core 2 having gaps many times. In order to simplify structure, the first reservoir chamber 3 may combine with the housing 23 of the fluid core 2 to form one part, the fluid core 2 directly contacts the first reservoir chamber 3, and the second exhaust outlet 22 between the additional reservoir chamber 4 and the fluid core 2 communicates directly with the first exhaust outlet 30 on the side. In this case, it is observed that the second exhaust outlet 22 is disposed on the fluid supply outlet 43 of the additional reservoir chamber 4 and communicates with the first exhaust outlet 30 on the side It is also observed that the second exhaust outlet 22 is disposed on the inlet 20 of the fluid core 2 and communicates with the first exhaust outlet 30 on the side, and the outlet 21 of the fluid core 2 communicates with the first exhaust outlet 30′ located below the first reservoir chamber 3. Such a structure may relatively reduce the configuration of the marking instrument, but not reduce distribution area of the fluid core 2

Referring to FIG. 5, the fluid supply outlet on the additional reservoir chamber 4 is an opening having closed slot 431 that can be opened. The opening having closed slot 431 may allow marking fluid not to be evaporated. When it needs to add marking fluid into the fluid core 2 having gaps and absorptive capacity, by pressing the hose 41, the pressed hose 41 lets marking fluid generate thrust force. The deformable hose 41 may also serve as fluid supply device in the additional reservoir chamber 4, opening the opening having closed slot 431 to release marking fluid.

At least one additional reservoir chamber is arranged outside of the first reservoir chamber. The first reservoir chamber and the additional reservoir chamber are arranged transversely along the length direction of the marking instrument. Please refer to the following examples for the details.

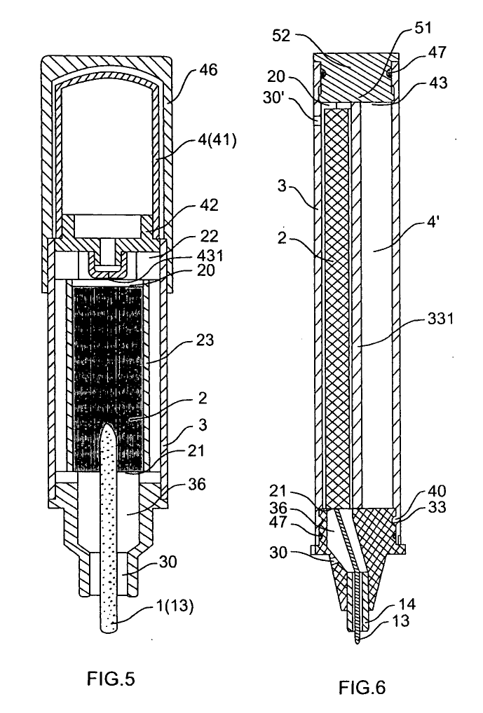

Referring to FIG. 6, an additional reservoir chamber 4′ is disposed outside of the first reservoir chamber 3 and arranged transversely along the length direction of marking instrument. Above the first reservoir chamber 3 and the additional reservoir chamber 4′ adjacent thereto is a sealer 51 which closes the fluid supply outlet 43 in the additional reservoir chamber 4′. When the marking fluid of the fluid core 2 of the first reservoir chamber 3 is used up or remains a little, pulling switch device 52 to move the sealer 51 up so as to communicate the fluid supply outlet 43 to the inlet 20 of the fluid core 2. At this time, the marking fluid in the additional reservoir chamber 4′ may flow or be absorbed into the fluid core 2 as long as the fluid supply outlet 43 is adown. The first reservoir chamber 3 and the additional reservoir chamber 4′ adjacent thereto may be integrated in a tube structure, and a partition 331 is positioned in center of the sleeve to separate them. Such a structure is relatively reasonable and convenient for producing.

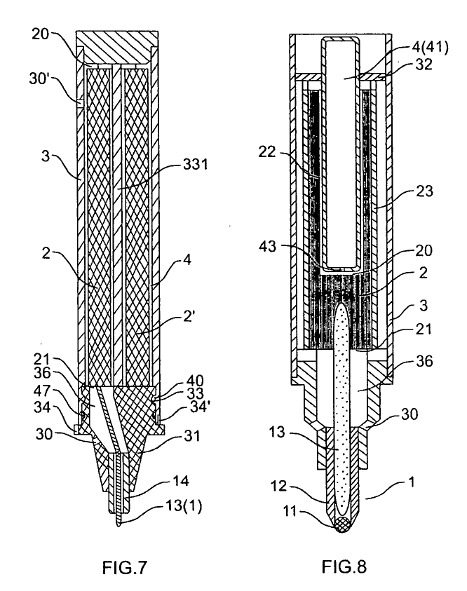

Referring to FIG. 7, additional reservoir chamber 4 is disposed at the side of the first reservoir chamber 3. The additional reservoir chamber 4 is also provided with fluid core 2′ for absorbing the marking fluid in the additional reservoir chamber 4 in the fluid core 2′. The first reservoir chamber 3 may be formed into a separate structure. Fixing sleeve 31 in the first reservoir chamber 3 for fixing the marking tip 1 is configured to rotatably connect with the first reservoir chamber 3. Marks 34 and 34′ are formed on the surface of the first reservoir chamber 3 and the fixing sleeve 31. When the marking fluid of the fluid core 2 is used up or remains a little, rotating the fixing sleeve 31 (rotating 180°) to communicate the fluid core 2′ in the additional reservoir chamber 4 with the fluid supply outlet 36 on the fixing sleeve 31 or to align the mark 34 to the mark 34′ such that the fluid core 2′ contacts a conducting fluid core 13 in the marking tip 1 so as to allow the marking tip 1 to obtain marking fluid again for continual writing.

At least one additional reservoir chamber may be arranged inside of the first reservoir chamber. At least one additional reservoir chamber in the first reservoir chamber is arranged inside or outside of fluid core. Please refer to the following examples for the details.

Referring to FIG. 8, at least one additional reservoir chamber 4 is arranged in the first reservoir chamber 3, and the most of the additional reservoir chamber 4 in the first reservoir chamber 3 is located inside of the fluid core 2. The fluid supply outlet 43 for supplying marking fluid to the fluid core 2 is disposed in the additional reservoir chamber 4 and communicates with the inlet 20 of the fluid core 2. The additional reservoir chamber 4 may be made of hose 41. The additional reservoir chamber 4 is fixed in the top 32 of the first reservoir chamber 3 and has a portion beyond the top 32 for facilitating pushing. Second exhaust outlet 22 is arranged on the side of the fluid supply outlet 43 or there is an interstice between the fluid supply outlet 43 and the fluid core 2 for discharging air, and first exhaust outlet 30 is positioned in the first reservoir chamber 3 and communicates with the second exhaust outlet 22. When it needs to add marking fluid into the fluid core 2, pushing the additional reservoir chamber 4 to add the marking fluid in the additional reservoir chamber 4 into the fluid core 2 such that the marking fluid newly absorbed by the fluid core 2 is supplied continually to the marking tip 1. Alternatively, the additional reservoir chamber 4 in the first reservoir chamber 3 may be located outside of the fluid core 2, i.e. on the side of the fluid core 2. Since the fluid core 2 has very strong absorptive capacity, an inlet may be formed on the fluid core 2 at any place for aligning or communicating with the fluid supply outlet of the additional reservoir chamber 4. When marking fluid extruded by the hose 41 is released from the fluid supply outlet, the marking fluid is absorbed by the fluid core 2 so as to supply continually marking fluid to the marking tip 1 with the fluid core 2.

The additional reservoir chamber may comprise a fluid supply device and the fluid supply device comprises a sealer and a switch device. Please refer to the following examples for the details.

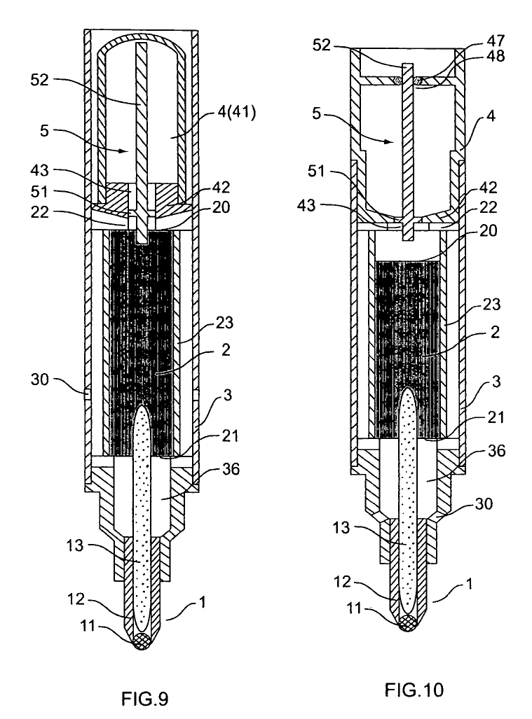

Referring to FIG. 9, the additional reservoir chamber 4 also comprises a fluid supply device 5. The fluid supply device 5 may comprise a sealer 51 positioned on the fluid supply outlet 43 and a switch device 52 connecting with the sealer 51. The fluid supply outlet 43 is disposed at the bottom of the additional reservoir chamber 4. The chamber casing of the additional reservoir chamber 4 may be formed from hose 41. The sealer 51 seals the fluid supply outlet 43. The additional reservoir chamber 4 carries marking fluid therein. When the marking fluid in the fluid core 2 of the first reservoir chamber 3 is used up or remains a little, extruding the top of the hose 41 down to push indirectly the switch device 52 mentioned above to open the fluid supply outlet 43 with the sealer 51 so as to release the marking fluid of the additional reservoir chamber 4 from the fluid supply outlet 43 and then add into the fluid core 2 having gaps and absorptive capacity such that the newly added marking fluid is absorbed into the gaps of the fluid core 2 so as to obtain the result that the marking instrument can be reused many times and writes fluidly. Such a structure is simple and convenient for use.

The fluid supply device 5 comprises a sealer 51 located on the fluid supply outlet 43 and switch device 52 connecting to the sealer 51. This structure may have many variations, for example, the switch device 52 passes through the fluid core 2 and extends to the marking tip 1 to join the marking tip 1. the marking tip 1 may be formed into a structure slidable along the longitudinal direction of the marking instrument. The switch device or the sealer may be provided with a springing device convenient for the marking tip 1 returning to its original position. When the marking fluid in the fluid core 2 is used up or remains a little, pressing the marking tip 1 to push the switch device 52 when the marking tip 1 retracts and move the sealer 51 on the switch device 52 from the fluid supply outlet 43 to open the fluid supply outlet 43 so as to discharge marking fluid once from the fluid supply outlet 43 of the additional reservoir chamber 4 into the fluid core 2. It is preferred that the additional reservoir chamber 4 has marking fluid in the amount similar to or the same as the amount in the fluid core 2. There is no way for marking fluid in the fluid core 2 to overflow the marking tip so as not to occur dropping and leaking even if it takes place shocking in the first reservoir chamber 3 or the switch device 52 moves longitudinally to generate attraction force mainly because the marking fluid is attached (locked) in the fluid core 2 having strong absorptive capacity.

Referring to FIG. 10, it may also provide an opening 48 at the top portion of the additional reservoir chamber 4. The other end of the switch device 52 passes through the opening 48 for facilitating being pushed and seals the opening 48. When it needs to add marking fluid to the fluid core 2 having gaps and absorptive capacity in the first reservoir chamber 3, pressing the other end of the switch device 52 to open the fluid supply outlet 43 such that the marking fluid of the additional reservoir chamber 4 flows towards the fluid core 2 having gaps. Such a structure opening the fluid supply outlet 43 with the fluid supply device 5 is very convenient for user. In order to enhance sealing at the touch place of the opening 48 and the other end of the switch device 52, a seal ring 47 may be positioned on the opening 48 to seal the other end of the switch device 52 into the seal ring 47 on the opening 48. It may also use a seal ring disposed between the fluid supply outlet 43 and sealer 51 to provide better sealing characteristic therebetween.

The fluid supply device may comprise a sealer on the fluid supply outlet, a second sealer on air inlet and a switch device connecting the sealer and the second sealer. Please refer to the following examples for the details.

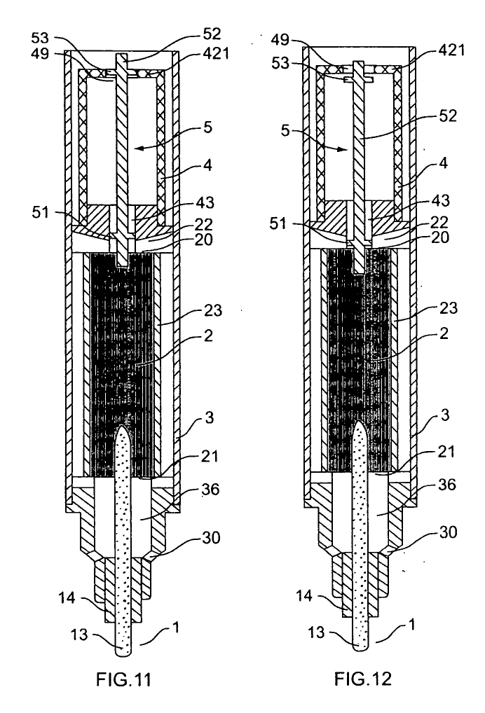

Referring to FIG. 11, air inlet 49 is formed on the top 421 of the additional reservoir chamber 4. The fluid supply device 5 comprises a sealer 51 on the fluid supply outlet 43, a second sealer 53 on the air inlet 49 and a switch device 52 connecting the sealer 51 and the second sealer 53. At the other end of the switch device 52 disposes the second sealer 53. The second sealer 53 seals the air inlet 49 in the additional reservoir chamber 4 with each other and the sealer 51 seals the fluid supply outlet 43 with each other. After the additional reservoir chamber 4 is charged with marking fluid therein, with pressing the switch device 52 on the top 421 of the additional reservoir chamber 4, the second sealer 53 of the switch device 52 moves on the air inlet 49 to communicate the air inlet 49 with air, and the sealer 51 also moves on the fluid supply outlet 43 at the same time to open the fluid supply outlet 43. In this way, the marking fluid of the additional reservoir chamber 4 is discharged from the fluid supply outlet 43 and absorbed by the fluid core 2 having absorptive capacity.

FIG. 12 is a schematic diagram showing the air inlet 49 and the fluid supply outlet 43 in opening status when the fluid supply device 5 of FIG. 11 is working. Since the air inlet 49 communicates with air after the fluid supply device 5 slides and the fluid supply outlet 43 is open by the sealer 51 at the same time, the inlet 20 of the fluid core 2 having gaps communicates with the air inlet 49 of the additional reservoir chamber 4 to prevent the new marking fluid in the fluid core 2 from suffering variation of temperature and/or atmosphere so as not to occur dropping and leaking. Although the structure of this embodiment is of an omnibearing open type, there is no way to affect the amount of marking fluid in the present invention. There is no way to occur dropping and leaking, but it enhances anti-leaking characteristic. It is not like structure of the prior art in which big and small reservoir chambers must be closed structure. In the prior art, if the big and small reservoir chambers are easy to have air therein, it is very easy for the marking fluid in the big and small reservoir chambers to flow out so as to occur dropping and leaking because there is nothing for the marking fluid in the small reservoir chamber to depend on. However, in this embodiment, since the newly added marking fluid is absorbed in the fluid core 2, there is no way for the marking instrument of the present invention to occur dropping and leaking even if the fluid supply device 5 generates shocking or attraction force during working One of the reasons is that the marking fluid in the first reservoir chamber 3 is absorbed (locked) in the fluid core 2.

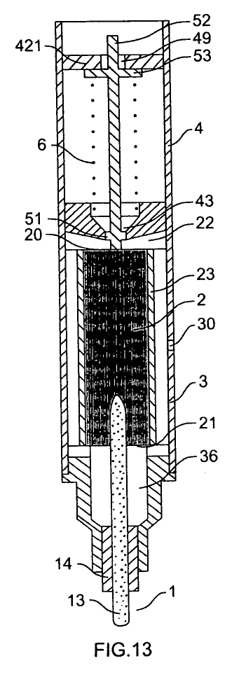

Referring to FIG. 13, air inlet 49 may be disposed on the top portion 421 of the additional reservoir chamber 4, the other end of the switch device 52 passes through the air inlet 49 for being pressed. The other end of the switch device 52 connects to second lealer 53. On the second sealer 53 disposes a restoring spring 6. With the restoring spring 6, the second sealer 53 seals the air inlet 49 on the top 421 of the additional reservoir chamber 4. When pressing the other end of the switch device 52, the sealer 51 and the second sealer 53 move to open the fluid supply outlet 43 of the additional reservoir chamber 4 and the air inlet 49 at the same time such that the marking fluid in the additional reservoir chamber 4 is discharged from the fluid supply outlet 43 and absorbed by the fluid core 2 having gaps smoothly.

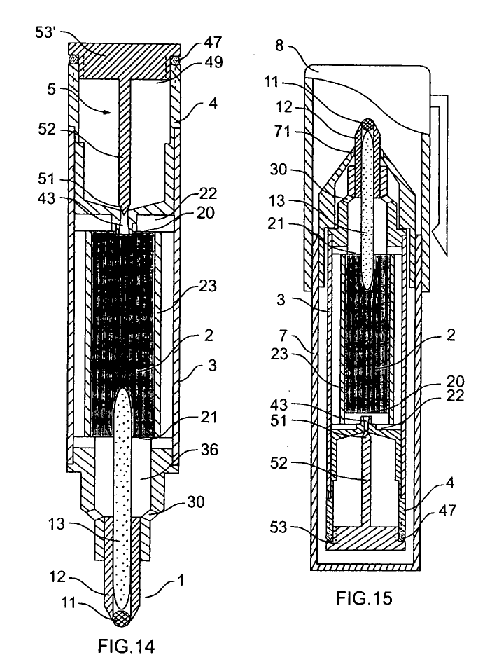

Referring to FIG. 14, the sealer 51 seals the fluid supply outlet 43. The switch device 52 is positioned above the sealer 51. The air inlet 49 may be disposed at the top of the additional reservoir chamber 4. Second sealer 53′ is disposed on the air inlet 49. The second sealer 53′ connects with the other end of the switch device 52. The second sealer 53′ seals the air inlet 49 of the additional reservoir chamber 4 with each other. In order to enhance sealing effect, it may dispose seal ring 47 between the air inlet 49 and the second sealer 53′. It may also produce the second sealer 53′ to have thread and be screwed in the air inlet 49. When opening (or screwing out) the second sealer 53′, the sealer 51 connecting with the switch device 52 moves away from the fluid supply outlet 43, and the fluid supply outlet 43 of the additional reservoir chamber 4 and the air inlet 49 are also opened at the same time such that the air comes into from the air inlet 49 and marking fluid is discharged from the fluid supply outlet 43 and absorbed smoothly by the fluid core 2 having gaps.

In order to seal the air inlet 49 with the second sealer 53′ at the same time that the sealer 51 seals the fluid supply outlet 43, it may dispose a spring between the switch device 52 and the second sealer 53′ or the switch device 52 may be formed from soft material. Even if there is difference in size in the switch device 52 during processing, it is possible to adjust the size by way of stretching and retracting characteristic of the spring or deformable characteristic of the soft materials so as to avoid the switch device 52 too long to seal the fluid inlet 49 with the second sealer 53′ or too short to seal the fluid supply outlet 43.

Referring to FIG. 15, the marking instrument may be put into pen tube 7 or be used as a changing core in the pen tube 7. As shown in this figure, the marking instrument of FIG. 14 is put into the pen tube 7. Third exhaust outlet 71 may be formed on the pen tube 7 for communicating with the first exhaust outlet 30 or there is space at the coupling place of the pen tube and marking instrument as a vent such that the second exhaust outlet 22 of the fluid core 2 is able to release air effectively. Cap 8 may be disposed on the pen tube 7 for carry or protecting the marking tip 1.

The fluid supply outlet of the additional reservoir chamber and the first reservoir chamber may seal with each other, and it may add fluid continually with relative rotation structure. Please refer to the following examples for the detail.

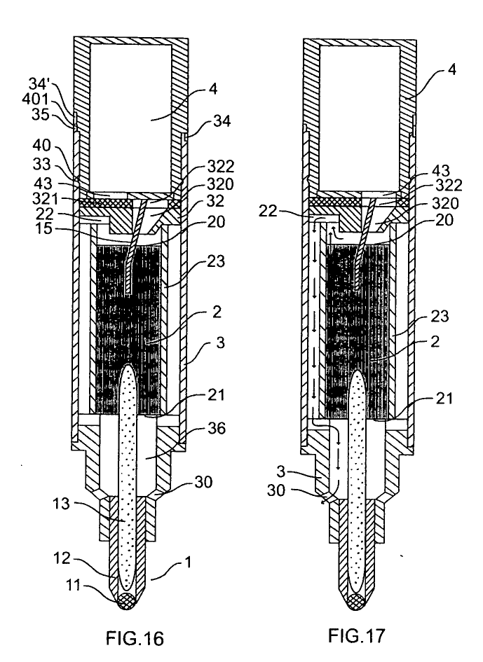

Referring to FIG. 16, on the top 32 of the first reservoir chamber 3 forms a fluid inlet 320 and the additional reservoir chamber 4 is positioned above the top 32 of the first reservoir chamber 3. The additional reservoir chamber 4 and the first reservoir chamber 3 may rotate relatively, as shown in FIG. 16. The fluid supply outlet 43 of the additional reservoir chamber 4 is an eccentric hole, and the eccentric hole and the top 32 of the first reservoir chamber 3 seal with each other and may rotate relatively. Between the top 32 of the first reservoir chamber 3 and the additional reservoir chamber 4 disposes a seal washer 321. Second opening 322 is disposed on the seal washer 321. The second opening 322 may align the fluid inlet 320 and is fixed with it together so as not to occur leaking at the connection of the additional reservoir chamber 4 and the top 32 of the first reservoir chamber 3. When the marking fluid in the fluid core 2 is used up or remains a little, rotating the additional reservoir chamber 4 with respect to the first reservoir chamber 3 in 180° or in the mark 34′ on the surface of the additional reservoir chamber 4 aligning the mark 34 of the first reservoir chamber 3 such that the fluid supply outlet 43 in the additional reservoir chamber 4 aligns and communicates with the fluid inlet 320 on the top 32 of the first reservoir chamber 3, the marking fluid in the additional reservoir chamber 4 flows into the fluid core 2 via the fluid supply outlet 43, the second opening 322 of the seal washer 321, the fluid inlet 320 of the first reservoir chamber 3 and inlet 20 (seeing FIGS. 16 and 17), and is absorbed into the fluid core 2, and the marking tip 1 may obtain marking fluid again for continual writing. Such a structure has the advantages of opening the fluid supply outlet 43 of the additional reservoir chamber 4 and releasing marking fluid as long as rotating the additional reservoir chamber 4 when it needs the marking fluid of the additional reservoir chamber 4. The structure is slick, reasonable, convenient for use and does not occur leaking at the rotating place.

Second conducting fluid core 15 may be disposed between the second opening 322 and the fluid core 2 so as to quickly conduct the marking fluid of the additional reservoir chamber 4 into the fluid core 2.

It may also position a fluid core in the additional reservoir chamber. The marking fluid may be absorbed in the fluid core. When it needs the marking fluid in the fluid core of the additional reservoir chamber, with rotating the additional reservoir chamber in 180°, the marking fluid absorbed in the fluid core of the additional reservoir chamber is conducted down into the fluid core of the first reservoir chamber 3 by the second conducting fluid core such that the fluid core of the first reservoir chamber connecting with the marking tip 1 obtains marking fluid again.

Referring to FIGS. 16, 18 and 19, it may dispose stopper 401 at the root of the connection of the additional reservoir chamber 4 and the first reservoir chamber 3, and stopping channels 35 is disposed at the opening portion of the first reservoir chamber 3 for fitting with the stopper 401. The stopping channel 35 is preferred in about 180°. When the fluid supply outlet 43 of the additional reservoir chamber 4 and the fluid inlet 320 of the first reservoir chamber 3 seal with each other, the stopper 401 substantially stops at one end of the stopping channel 35. When it needs to align and communicate the fluid supply outlet 43 of the additional reservoir chamber 4 to the fluid inlet 320 of the first reservoir chamber 3, relatively rotating the first reservoir chamber 3 or the additional reservoir chamber 4 until they cannot be rotated, i.e. when the stopper is rotated to another end of the stopping channel 35, the fluid supply outlet 43 of the additional reservoir chamber 4 has aligned the fluid inlet 320 of the first reservoir chamber 3 such that the marking fluid in the additional reservoir chamber 4 flows into the fluid core 2 so as to supply continually marking fluid to the marking tip 1. Such a structure is simple, reasonable and easy for use. The stopper and stopping channel may be fit with each other and are disposed at the center position of the coupling place therebwteen. The stopper on the additional reservoir chamber 4 and the stopping channel in the first reservoir chamber 3 may be exchanged.

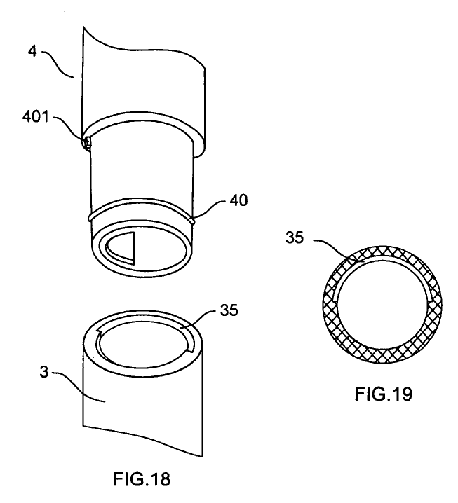

Referring to FIGS. 16 and 18, flange 40 is disposed at the coupling place between the additional reservoir chamber 4 and the first reservoir chamber 3, and recess 33 is disposed at the coupling place between the first reservoir chamber 3 and the additional reservoir chamber 4 to serve as locking when they couple each other and prevent them from falling off or fluid from leaking.

Referring to FIG. 16, in order to facilitate aligning the fluid supply outlet 43 of the additional reservoir chamber 4 to the fluid inlet 320 of the first reservoir chamber 3, it may dispose a mark 34′ on the surface of the additional reservoir chamber 4 at the connection connecting with the first reservoir chamber 3. The mark 34′ may be a graduation, or a colored dot or line, or a groove, or the like. A mark 34 is formed on the surface of the first reservoir chamber 3 at the connection connecting with the additional reservoir chamber 4. The mark 34 may be a graduation, or a colored dot or line, or a groove, or the like. The mark 34 is preferably disposed in about 180° away from the mark 34. In this way, when the marking fluid of the fluid core 2 is used up, as long as rotating 180° to allow the mark 34 to align the mark 34′, the fluid supply outlet 43 of the additional reservoir chamber 4 aligns the fluid inlet 320 of the first reservoir chamber 3 such that the marking fluid of the additional reservoir chamber 4 passes through the fluid supply outlet 43 and the fluid inlet 320 and then flows into the fluid core 2 so as to supply marking fluid continually to the marking tip 1.

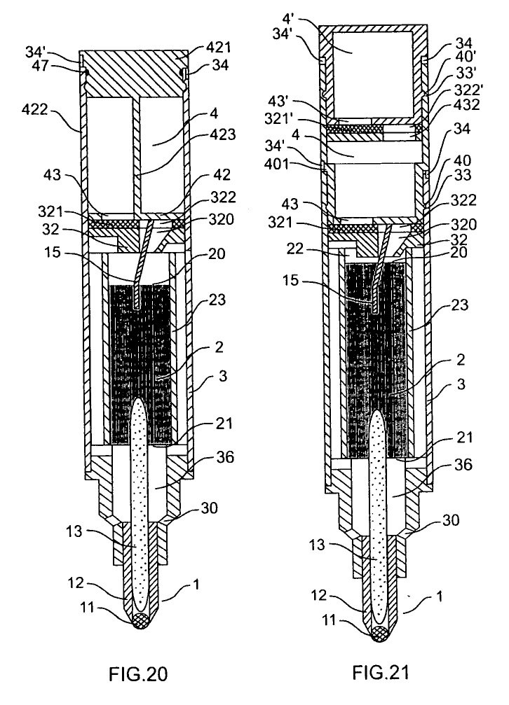

FIG. 20 is a modification of FIG. 16. In this embodiment, the top 421 and the bottom portion 42 of the additional reservoir chamber 4 are configured to rotatably connect with chamber casing 422. The top 421 and the bottom 42 are interconnected by a center shaft 423 disposed in the middle. When rotating the top 421 of the additional reservoir chamber 4, with rotation of the fluid supply outlet 43 of the bottom 42 driven by the center shaft 423, the fluid supply outlet 43 of the additional reservoir chamber 4 and the top 32 of the first reservoir chamber 3 rotate relatively such that the marking fluid of the additional reservoir chamber 4 flows into the fluid core 2 via the fluid supply outlet 43 and the fluid inlet 320.

A seal ring 37 is disposed between the top portion 421 and the chamber casing 422 to prevent leakage at the connection therebewteen.

Referring to FIG. 21, the marking instrument may be also provided with another additional reservoir chamber 4′ arranged above the additional reservoir chamber 4. Second fluid inlet 432 is formed at the top of the additional reservoir chamber 4, and a fluid supply outlet 43′ is formed at the bottom of the additional reservoir chamber 4′. A seal washer 321′ is arranged between the fluid supply outlet 43′ and the second fluid inlet 432. The seal washer 321′ is provided with an opening 322′ communicating with the second fluid inlet 432. When the fluid supply outlet 43 of the additional reservoir chamber 4 aligns and communicates with the fluid inlet 320 of the first reservoir chamber 3 and the marking fluid of the additional reservoir chamber 4 is used up, with rotating the additional reservoir chamber 4′ with respect to the first reservoir chamber 3, the fluid supply outlet 43′ of the additional reservoir chamber 4′ aligns and communicates with the second fluid inlet 432. In this way, the marking fluid of the additional reservoir chamber 4′ flows into the fluid core 2 via the fluid supply outlet 43′, the second fluid inlet 432 and the fluid outlet 320 such that a plurality of the additional reservoir chambers supply marking fluid in turn to the fluid core 2 of the first reservoir chamber 3 so as to provide marking fluid continually for the marking tip 1, which greatly extends writing time and enables fluid writing.

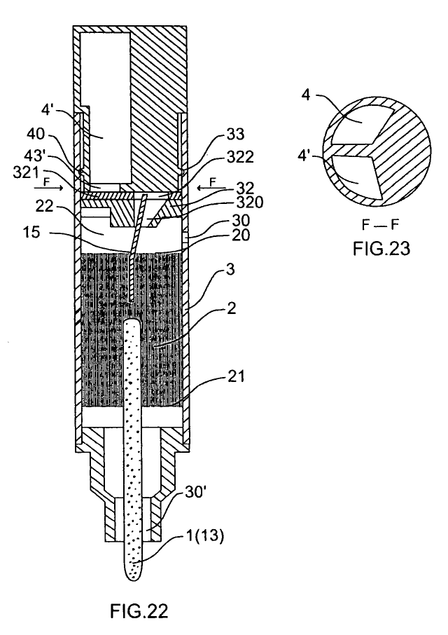

Referring to FIGS. 22 and 23, two additional reservoir chambers 4 and 4′ may be arranged in parallel above the first reservoir chamber 3. When the marking fluid in the fluid core 2 is used up or remains a little, with rotating the fluid supply outlets of the additional reservoir chambers 4 and 4′ in turn to align and communicate to the fluid inlet 320 of the first reservoir chamber 3, the marking instrument may obtain marking fluid many times for continual writing. FIG. 23 is a cross-section taken along F-F of FIG. 22. FIG. 22 only shows one of the additional reservoir chambers and does not show the additional reservoir chamber 4 because it is a cross-section diagram.

The marking tip 1 may use any marking tip usually used for writing. For example, the marking tip 1 may be a conducting fluid core 13 (seeing FIG. 3), and it may dispose an outer sleeve 14 outside of the conducting fluid core 13 (seeing FIG. 11). The marking tip 1 may also comprise a conducting fluid core 13, a ball 11 and a ball sleeve 12 (seeing FIG. 1), and it may also comprise a conducting fluid core 13 and a conventional pen tip or a tip with a gap. The marking fluid may be any one available in the market. The marking tip 1 is used to apply the marking fluid to surfaces of any solid material, such as, paper, box, floor, bag, wall, article, etc.

While the invention has been illustrated and described in detail in the drawings and foregoing description, such illustration and description is to be considered as exemplary and not restrictive in character, it being understood that only the preferred embodiment has been shown and described and that any changes and modifications that come within the spirit of the invention are described to be protected.

What is claimed is:

1. A marking instrument, the marking instrument comprising: a marking tip for applying marking fluid on surface of written media, a first reservoir chamber having a fluid supply outlet for supplying the marking tip with marking fluid, in characterized that said instrument further comprises at least one additional reservoir chamber located inside or outside of the first reservoir chamber, the additional reservoir chamber is provided with a fluid supply outlet for supplying marking fluid to the first reservoir chamber, the first reservoir chamber comprises a fluid core having absorptive capacity, and the fluid core comprises an inlet and an outlet, wherein the inlet of the fluid core communicates with the fluid supply outlet of the additional reservoir chamber and the outlet of the fluid core communicates with the marking tip, and wherein a first exhaust outlet is formed in the first reservoir chamber and communicates with the fluid core such that the marking fluid in the at least one additional reservoir chamber is conducted to the marking tip via the fluid core of the first reservoir chamber so as to supply marking fluid continually to the marking tip.

2. The marking instrument of claim 1, further comprising a second exhaust outlet disposed between the additional reservoir chamber and the fluid core or on the fluid core, wherein the second exhaust outlet communicates with the first exhaust outlet.

3. The marking instrument of claim 1 or 2, wherein the at least one additional reservoir chamber disposed outside of the first reservoir chamber and the first reservoir chamber are arranged end to end along the length direction of the marking instrument, and the at least one additional reservoir chamber is located above the first reservoir chamber.

4. The marking instrument of claim 1 or 2, wherein the at least one additional reservoir chamber disposed outside of the first reservoir chamber and the first reservoir chamber are arranged transversely along the length direction of the marking instrument.

5. The marking instrument of claim 1 or 2, wherein the at least one additional reservoir chamber disposed inside of the first reservoir chamber is located inside or outside of the fluid core.

6. The marking instrument of claim 1 or 2, wherein the fluid core is a fiber fluid core.

7. The marking instrument of claim 1, 2, 3, 4, 5, or 6, wherein the additional reservoir chamber further comprises a hose and bottom, the fluid supply outlet is formed at the bottom, and the fluid supply outlet is an opening having closed slot which can be opened or the fluid supply outlet is provided with a stemming.

8. The marking instrument of claim 1, 2, 3, 4, 5, or 6, wherein the additional reservoir chamber further comprises a fluid supply device.

9. The marking instrument of claim 8, wherein the fluid supply device comprises a sealer disposed on the fluid supply outlet and a switch device connecting with the sealer.

10. The marking instrument of claim 8, further comprising an air inlet formed at the top of the additional reservoir chamber, wherein the fluid supply device comprises a sealer disposed on the fluid supply outlet, a second sealer on the air inlet and a switch device connecting the sealer and the second sealer.

11. The marking instrument of claim 1, 2, or 3, further comprising an fluid inlet formed at the top of the first reservoir chamber, wherein the additional reservoir chamber is disposed above the top, and the fluid supply outlet of the additional reservoir chamber and the top of the first reservoir chamber seal with each other and relatively rotatably connect with each other.

12. The marking instrument of claim 11, further comprising a seal washer disposed between the top of first reservoir chamber and the additional reservoir chamber.

13. The marking instrument of claim 11, further comprising marks on the first reservoir chamber and the additional reservoir chamber for aligning.

14. The marking instrument of claim 11, further comprising a stopper or stopping channel at the coupling place of the additional reservoir chamber and the first reservoir chamber and a stopping channel or stopper at the coupling place of the first reservoir chamber and the additional reservoir chamber for fitting with the stopper or stopping channel.

15. The marking instrument of claim 1, 2, 3, or 4, wherein the additional reservoir chamber comprises a fluid core.
